(19) United States
(12) Patent Application Publication
(10) Pub. No.: US 2007/0239079 A1
(43) Pub. Date: Oct. 11, 2007

(54) METHOD AND APPARATUS FOR SELECTIVE TREATMENT OF BIOLOGICAL TISSUE USING ULTRASOUND ENERGY

(75) Inventors: Dieter Manstein, Boston, MA (US); Hans-Joachim Laubach, Neuerburg (DE); R. Rox Anderson, Boston, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 11/697,852

(22) Filed: Apr. 9, 2007

Related U.S. Application Data
(60) Provisional application No. 60/790,170, filed on Apr. 7, 2006.

(51) Int. Cl. A61H 1/00

(52) U.S. Cl. 601/2

(57) ABSTRACT

A method and apparatus are provided for dermatological treatment by focusing ultrasound energy in a volume of tissue below the dermis to obtain selective heating and thermal damage of certain portions of the volume while sparing other portions of the treatment volume from thermal damage. Selective heating of fibrous septae can be achieved while relatively sparing surrounding fatty tissue, which can lead to some shrinkage of the fibrous septae and reduction in the appearance of wrinkles. The matrix of hair follicles can also be selectively heated to provide relatively safe temporary or permanent hair removal. The superficial musculoaponeurotic system can also be selectively heated to obtain a tightening of the overlying skin.

### CROSS-REFERENCE TO RELATED APPLICATION

This application is based upon and claims the benefit of priority from U.S. Patent Application Ser. No. 60/790,170, filed Apr. 7, 2006, the entire disclosure of which is incorporated herein by reference.

### FIELD OF THE INVENTION

The present invention relates to methods and apparatus for medical and cosmetic treatments using ultrasound energy and, more particularly, to such methods and apparatus which are capable of selectively heating certain tissues to obtain therapeutic and/or cosmetic results.

### BACKGROUND INFORMATION

Controlled heating of bodily tissues can be used to achieve various therapeutic and cosmetic effects. Examples include hair removal, removal of tattoos and other skin markings, tightening of collagen structures to reduce wrinkles or improve the appearance of cellulite, etc. The heating can be accomplished by applying various forms of energy to targeted regions of tissue. The energy may be in the form of, e.g., electromagnetic radiation, microwave radiation, radio frequency waves, lasers, ultrasound energy, or infrared radiation.

It may be preferable to apply energy to tissue in select regions to limit the amount of damage done and to confine such damage to certain regions or features within the tissue. For example, focused electromagnetic radiation may be used to selectively heat and damage isolated regions at a desired depth within skin tissue. U.S. Patent Publication No. 2002/0161357 method and apparatus that use focused radiation to selectively heat and damage isolated regions at a desired depth within skin tissue. Surface cooling may be preferred in such treatments to reduce or avoid damage to the surface regions overlying the target areas to be heated. According to this publication, cooling rates can be carefully balanced with the intensity of delivered energy to ensure that the desired target regions are heated sufficiently while surrounding areas of tissue are not damaged.

Substances that preferentially absorb energy, such as chromophores, may be used to assist targeting of specific regions of tissue to be heated. Such substances may be naturally present in the treated tissue, or they may be deliberately introduced. For example, certain hair removal treatments involve the application of optical energy to the skin. Darker hair follicles may preferentially absorb such energy, possibly leading to damage of the follicles and cessation of hair growth. Such exemplary approach to managing hair growth is described, e.g., in International Patent Publication No. WO 03/07783.

The use of chromophores to preferentially absorb energy may limit the application of thermal treatments in certain tissues. For example, darker skin may absorb too much of the applied energy to preclude selective absorption by hair follicles. In addition, such thermal treatments may not be useful for limiting growth of lighter hair follicles. Chromophores or other energy-absorbing substances present within the treated tissue may also limit the depth at which regions can be targeted, because too much of the applied energy may be absorbed before it can reach the target depth. This can also lead to unwanted thermal damage at shallower depths below the skin surface.

One potential application of a thermal treatment is to heat collagen structures, such as the fibrous septae located in the subdermal fatty layer. Heating of these protein structures can lead to shrinkage of the septae, which can result in tightening of the skin and/or improvement in the appearance of cellulite. An application of optical or electromagnetic radiation to tissues below the dermis can be difficult, as much of the applied energy can often be absorbed by the upper skin layers without appropriately affecting the intended target area.

Directing energy to specific areas of tissue can be difficult and time-consuming, and it may require complex devices to achieve the desired targeted heating effects. For example, U.S. Patent Publication No. 2005/0154332 describes a method for focusing high-intensity acoustic energy onto individual hair follicles to facilitate permanent hair removal. According to this publication, individual follicles are first located using acoustic imaging, and the point-focused energy is then applied to the follicles individually. Such methods can be very time-consuming and inefficient.

Many forms of energy used to treat skin and other tissues by targeted heating can also be inherently dangerous, and may need to be applied by trained professionals. For example, lasers can cause unwanted damage, such as burns, if their application is not carefully controlled. They can also lead to retinal damage and loss of vision if aimed at an eye. Certain energy sources such as lasers or radio frequency (“RF”) generators may also be bulky and/or expensive.

Acoustical energy such as ultrasound waves, may also be applied to living tissue to cause heating for therapeutic purposes. For example, a method and apparatus for applying a focused ultrasound beam to head the dermal layer of skin is described, e.g., in U.S. Pat. No. 6,113,559 and U.S. Patent Publication No. 2006/0184071. Control of the amount of energy applied to regions of tissue by such application of ultrasound energy may be difficult, and precise controlled effect on the tissue that is to be thermally damaged may not be easy.

Therefore, there may be a need to provide processes, systems and apparatus which combine safe and effective treatment for improvement of dermatological conditions with minimal side effects, and to overcome at least some of the deficiencies discussed herein above.

### OBJECTS AND EXEMPLARY EMBODIMENTS OF THE INVENTION

One of the objects of the present invention is to provide exemplary embodiments of a process and apparatus for selective heating of regions of tissue to achieve desired cosmetic and therapeutic effects. Another object of the present invention is to provide processes, systems and apparatus that are configured to be able to cause thermal damage to select regions of tissue while sparing adjacent regions from the thermal damage, where the regions may be located below a dermis.

Yet another object of the present invention is to provide processes, systems and apparatus for temporary or permanent hair removal or control of hair growth.

A further object of the present invention is to provide a process and apparatus for hair removal or control of hair growth that is safe for home use.

A still further object of the invention to provide an apparatus and method for selectively heating collagen structures, which may be located within the subdermal fatty tissue, while avoiding thermal damage of the fatty tissue. Heating of such collagen structures may be performed, for example, to reduce or eliminate the appearance of wrinkles, and/or to improve the appearance of cellulite.

These and other objects can be achieved with the exemplary embodiments of the processes and apparatus according to the present invention, in which focused ultrasound energy can be directed to a portion of tissue containing target regions therein to be heated. The characteristics of the directed energy may be controlled to provide selective absorption of the energy by the target regions, which may include distinct structural features within the portion of tissue receiving the focused energy.

In another exemplary embodiment of the present invention, an apparatus can be provided that includes a source of focused ultrasound energy. The source can be enclosed in a housing, and may be configured to provide a linear focus of ultrasound energy that can be scanned transversely over a region of skin or other tissue. Alternatively or in addition, the source may include an array of point-focused transducers that can be scanned transversely over a region of skin or other tissue. The parameters of the energy source may be pre-set to specific values or, alternatively, one or more parameters may be adjustable to achieve desired results on different areas of a body.

In another exemplary embodiment of the present invention, ultrasound energy may be focused on a portion of a biological structure. The characteristics of the waves may be adjusted so that some regions exposed to the ultrasound energy undergo thermal damage by absorbing energy from the ultrasound energy, whereas another adjacent region exposed to a similar intensity of acoustic energy is not thermally damaged.

In certain exemplary embodiments of the present invention, the source of energy may be configured to produce selective heating and/or thermal damage of collagen structures within or beneath the skin while sparing adjacent or nearby tissue from such damage. These collagen structures can include fibrous septae or the superficial musculoaponeurotic system (SMAS), which may be located in subepidermal fatty tissue.

According to further exemplary embodiments of the present invention, the source of energy may be configured to produce selective heating and/or thermal damage to anagen hair matrix and/or portions of a hair follicle epithelium while avoiding thermal damage to surrounding fatty tissue. Such heating or thermal damage can result in temporary or permanent cessation of growth of the treated follicles.

These and other objects, features and advantages of the present invention will become apparent upon reading the following detailed description of embodiments of the invention, when taken in conjunction with the included drawings and appended claims.

### BRIEF DESCRIPTION OF THE DRAWINGS

For a more complete understanding of the present invention and its advantages, reference is now made to the following description, taken in conjunction with the accompanying drawings, in which:

FIG. 1 is an illustration of an exemplary apparatus that may be used in accordance with exemplary embodiments of the present invention;

FIG. 2 is an illustration of an exemplary embodiment of a line-focused ultrasound source that may be used in accordance with exemplary embodiments of processes and/or apparatus of the present invention;

FIG. 3 is an illustration of an exemplary swept path of the ultrasound source of FIG. 2 and the region of treated skin associated therewith;

FIG. 4 is an illustration of a cross-sectional view of exemplary steps of a process for selectively heating the fibrous septae and the use of an exemplary apparatus in accordance with exemplary embodiments of the present invention;

FIG. 5 is an exemplary image of a cross-section of a skin tissue treated with focused ultrasound, illustrating selective heating of the fibrous septae in accordance with the exemplary embodiments of the processes and/or apparatus of the present invention; and

FIG. 6 is an illustration of a cross-sectional view of exemplary steps of a process for selectively heating the fibrous septae and the use of an apparatus in accordance with exemplary embodiments of the present invention.

Throughout the drawings, the same reference numerals and characters, unless otherwise stated, are used to denote like features, elements, components, or portions of the illustrated embodiments. Moreover, while the present invention will now be described in detail with reference to the Figures, it is done so in connection with the illustrative embodiments.

### DETAILED DESCRIPTION OF EXEMPLARY EMBODIMENTS OF THE INVENTION

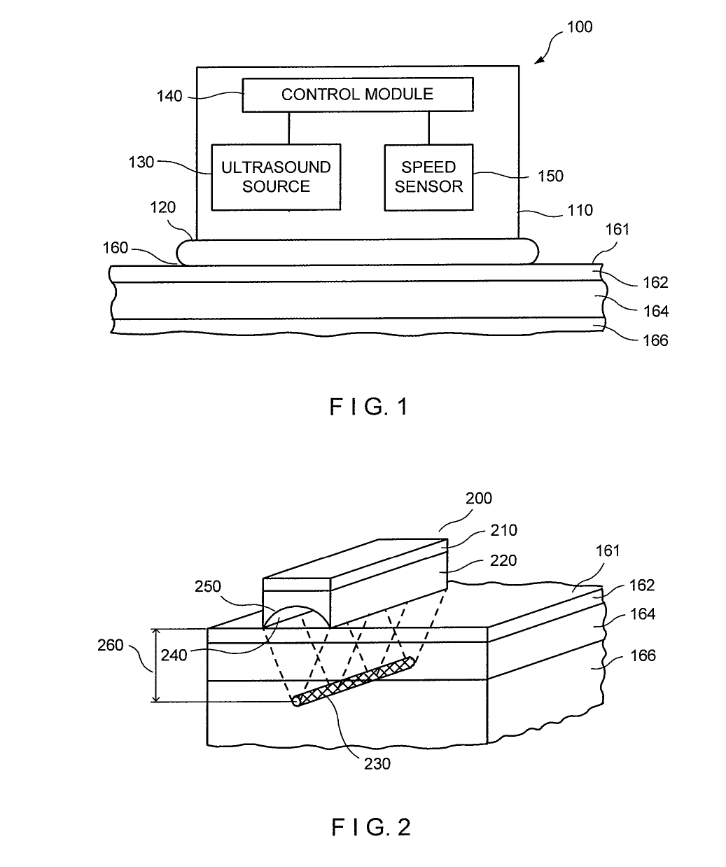

FIG. 1 illustrates an exemplary embodiment of a general system 100 suitable that can be used in accordance with the exemplary embodiments of the present invention. In FIG. 1, an area 160 of a biological tissue is shown on which a selected thermal treatment may be performed. The biological tissue can include an epidermal layer 162 having an upper surface 161, a dermal layer 164, and/or a subdermal fatty layer 166.

The system 100 can include a housing 110, a source of ultrasound energy 130, a control module 140, and an optional speed sensor 150. One or more of these components may be located within the housing 110. The housing 110 may optionally be configured as a handpiece that can include a handle or other projection that may be held by a user, and allow the user to translate the housing 110 and attached ultrasound source 130 over the skin surface 161. An acoustic coupling medium 120 may also be provided to improve the acoustic coupling between the ultrasound source 130 and the skin 160. The coupling medium may be in the form of a topical gel or the like, which may be applied directly to the upper surface 161 or contained, e.g., in a flexible polymer membrane.

The ultrasound energy source 130 can be configured to generate high-intensity ultrasound energy. This energy may be focused such that its intensity is maximized at a desired focal depth or within a focal zone below the surface. A focused delivery of the ultrasound energy to an anatomical structure is described, for example, in U.S. Patent Publication No. 2005/0143677. The ultrasound source 130 may have a fixed focal length, and can be attached to the housing 110 such that the height of the source 130 above the surface of the skin may be adjustable. This exemplary configuration can facilitate an accurate setting of the depth of the applied focused energy below the surface of the skin 161 by adjusting the position of the ultrasound source 130 within the housing 110. Alternatively, the apparatus 100 may be provided with a fixed focal distance below the bottom of the housing 110 for certain applications.

The control module 140 can include a switch that can turn the power supplied to the ultrasound source 130 on or off. The control module 140 may optionally be configured to vary other parameters associated with the ultrasound source 130. Such exemplary parameters can include, e.g., power intensity, focal depth, pulse duration, frequency, etc.

FIG. 2 is an illustration of an exemplary embodiment of a linear focused ultrasound energy source 200 that may be used with the systems 100 and other exemplary embodiments of the present invention. The ultrasound energy source 200 can include a transducer 210 that is capable of producing ultrasonic waves. A concave cylindrical element 220 can be attached (e.g., acoustically coupled) to the transducer 210. The shape of the concave surface 240 of the cylindrical element 220 can be provided such that the ultrasonic waves generated by the transducer 210 are focused approximately along a line 230. The cross-sectional profile 250 of the cylindrical element 220 may be circular or parabolic, or it may have another shape. The profile 250 should be in a shape so as to provide a focused line of energy 230. The shape of the profile 250 may partially depend, e.g., on the material(s) forming the transducer 210 and the cylindrical element 220, the frequency and power level at which the transducer 210 is operated, the acoustic transmission characteristics of the tissue being treated, etc. The line focused ultrasound energy may thus be directed to a depth 260 below the upper surface 161 of the skin.

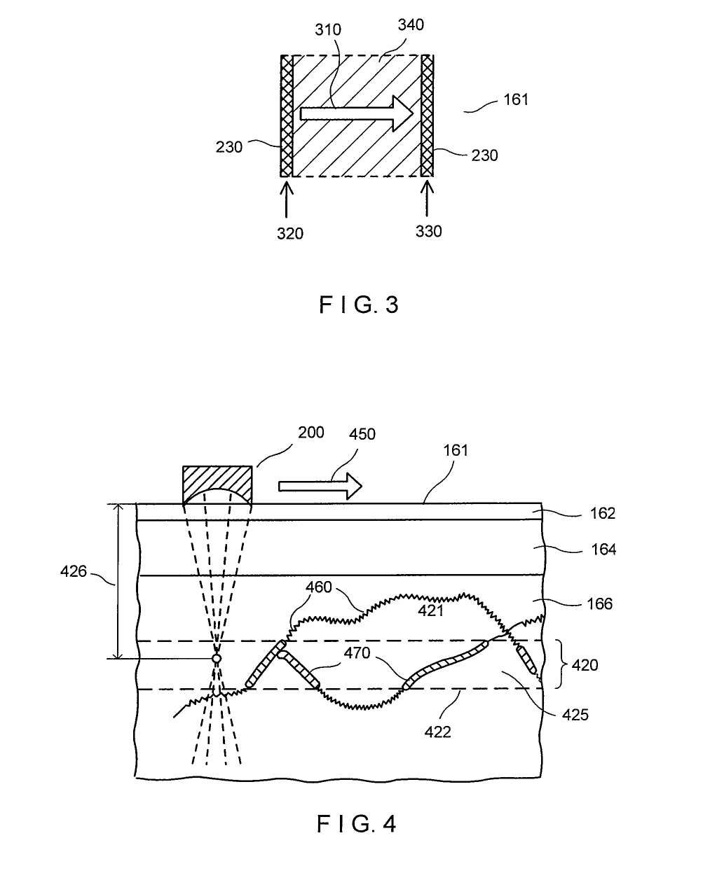

FIG. 3 shows a top view of an exemplary procedure for applying the focused ultrasound energy to a biological tissue in accordance with exemplary embodiments of the present invention. For example, a line trace 230 represents a top view of the linear focus pattern of ultrasound energy that is initially provided at a location 320. The ultrasound source 130 can be translated along the direction 310, such that the line trace 230 is moved to a second location 330. The direction 310 may be approximately perpendicular to the line trace 230. In this manner, the ultrasound energy can be applied approximately uniformly at a predetermined depth beneath the entire region 340.

The exemplary system 100 shown in FIG. 1 may optionally include a speed sensor 150 that is capable of preventing an excessive thermal damage to the biological tissue being treated. This can be achieved by, e.g., controlling, limiting, and/or shutting off the power supplied to the ultrasound source 130 in response to the rate at which the ultrasound source 130 traverses the biological tissue being treated. The speed sensor 150 can be configured to detect and/or control the speed at which the housing 110 containing the ultrasound source 130 is scanned across the skin surface 161. This speed can correspond to the speed at which the trace of the linear focused ultrasound energy 230 shown in FIG. 3 moves along the path 310. The speed sensor 150 may include, e.g., a mechanical wheel, an LED, or another mechanical or optical sensor, etc., which can be configured to sense or detect the speed at which the housing 110 is translating with respect to the biological tissue.

The speed sensor 150 can communicate with the control module 140 in FIG. 1, which can be configured to vary the power supplied to the ultrasound source 130 in response to the detected translational speed of the housing 110 and attached ultrasound source 130 along the upper surface 161 of the skin. The control module 140 can also be configured to turn off the power to the ultrasound source 130 e.g., if the translational speed of the housing 110 falls below a minimum value, and/or if the translation direction is reversed. The control module 140 can also be configured to control the power supplied to the ultrasound source 130 such that the intensity of the ultrasound energy produced thereby is approximately proportional to the translational speed of the housing 110. This can result in a relatively uniform density of energy being delivered at the desired depth within the area 160 of the biological tissue as the housing 110 traverses the upper surface 161 of the biological tissue.

In further exemplary embodiments of the present invention, the ultrasound source 130 may include one or more rows of point-focused ultrasound transducers, or an array of such transducers. The individual transducers may be attached to the housing 110 at a uniform distance above the lower surface of the housing 110, and/or they may be located at different heights with respect to the target area 160. The individual transducers may each have the same focal depth or they may have different focal depths. Translating the rows or arrays of point-focused ultrasound transducers across the surface of the skin can provide focused ultrasound energy at one or more depths below the upper surface 161 of the skin. A collection of point arrays may not provide an applied energy distribution that is as uniform as that which may be provided using the line-focused ultrasound energy source 200 shown in FIG. 2. However, the distribution of applied ultrasound energy provided by an exemplary embodiment of an arrangement or array of point-focused sources may be preferable in some applications.

In still other exemplary embodiments of the present invention, the system, process and apparatus may be configured to generate selective heating of fibrous septae within the subcutaneous fatty layer without the need for feedback control or imaging to locate specific target regions to be heated. The heating of the fibrous septae can lead to shrinkage of the collagen structure, tightening of the overlying skin, and/or improvement in the appearance of cellulite.

Selective heating of the fibrous septae using the system, process and apparatus in accordance with the exemplary embodiment of the present invention as a cross-sectional view is illustrated in FIG. 4. This exemplary illustration shows a source of high-intensity line-focused ultrasound energy (HIFU) 200 provided over a section of tissue to be treated. The ultrasound energy is focused to a focal zone 420 located within the subdermal fatty layer 166. The focal zone 420 may be understood to represent a range of distances below the skin surface 161 at which the intensity of supplied energy, e.g., ultrasound energy, is greater than a particular threshold value. The focal depth 426 may be understood to represent a distance below the upper section of the skin surface 161 at which the applied energy has a maximum value.

As shown in FIG. 4, the volume of the biological tissue 425 to be treated is provided between the upper limit 421 of the focal zone and the lower limit 422 of the focal zone. The focal depth 426 can generally be located within the focal zone 420. The height of the focal zone 420 can depend on several parameters including, e.g., the power supplied to the energy source, the focus geometry, the characteristics of the skin tissue, etc. The upper and lower boundaries limits 421, 422 of the focal zone 420 may not be exactly delineated as shown in FIG. 4, but instead may represent approximate distances below the surface between which the intensity of the applied energy exceeds some particular value.

The ultrasound source 200 may be scanned across the skin surface 161 in the direction 450, which can correspond to path 310 in the top view illustrated in FIG. 3. In this manner, the volume of biological tissue to be treated 425 can be exposed to at least a minimum intensity of applied ultrasound energy. Tissue located above and below the focal zone 420 may be exposed to some lesser intensity of applied energy, and therefore may not suffer any thermal damage.

The fatty layer 166, that can include the treatment volume 425, contains both fatty tissue and fibrous septae 460, which are stringy structures formed from collagen. The parameters of the applied ultrasound energy can be selected so that the energy is preferentially absorbed by portions of the fibrous septae 470 that are present within the focal zone 420, at an intensity sufficiently high to induce thermal damage to this collagen structure within the treatment volume 425. The fatty tissue within the treatment volume 425 can be spared from such thermal damage because such fatty tissue does not absorb sufficient energy to cause unwanted damage. In addition, the biological tissue provided above and below the treatment volume 425 would also remain undamaged after the application of the ultrasound energy because the intensity applied to these areas may be lower than that within the treatment volume 425, and insufficient to cause thermal damage.

For example, to achieve selective absorption of the ultrasound energy by fibrous septae while avoiding thermal damage to adjacent fatty tissue, the ultrasound energy may have a frequency in the range of about 1 to 10 MHz, and more preferably about 3 to 8 MHz, and even more preferably about 5 MHz. The focal depth of the applied energy may be about 2 mm to 20 mm, and preferably about 5 mm to 10 mm. The selected depth can depend on the region of tissue being treated, as the depth of the dermal layer may vary over different parts of a body. In general, it may be preferable to select the focal depth that is greater than the local thickness of the dermis, so that the ultrasound energy is focused within the fatty layer 166.

For an exemplary array of point-focused ultrasound sources, the maximal power output of each ultrasound energy source can be, e.g., about 5 to 20 W. The spot size at the focal depth can be, e.g., about 0.5-1 mm, and a scanning velocity of, e.g., about 0.5 to 15 cm/s can be used, or preferably about 0.5 to 5 cm/s. These exemplary parameters result in a local energy exposure of, e.g., up to about 1000 J/cm² for the regions of tissue near the focal plane that were exposed to the point-focused energy. This exemplary energy exposure value may be set somewhat higher or lower to provide sufficient heating of the fibrous septae, while avoiding unwanted thermal damage to the tissue surrounding the septae within the treatment volume. The selection of the maximum power output may depend on several factors including, e.g., the focus geometry. The ultrasound energy source 200 may be operated in a continuous wave (CW) mode, a pulsed mode and/or a mode where the ultrasound waves are modulated by a lower-frequency wave.

If the ultrasound energy is provided in a focused line having a width of about 0.5-1 mm, then the output power of the linear-focused transducer 210 may be in the range of, e.g., about 40-200 W per cm of the focused line. The scanning velocity again can be, e.g., about 0.5-15 cm/s, or preferably about 0.5 to 5 cm/s. These exemplary values can be based on directing the same total amount of power per unit area to the tissue being treated for both spot-focused and line-focused ultrasound sources. However, the power preferences of a line-focused source 200 may be somewhat higher than that of an array of point-focused sources, because the line-focused source can provide more uniform and complete coverage of the treated area for the same scanning velocity. There generally may be some regions of tissue between the point sources at the focal depth that are not directly exposed to the focused ultrasound energy. This can be addressed by, e.g., performing multiple passes of the apparatus over a treatment area, where the passes may be approximately parallel or at an angle to each other.

Inducing thermal damage to the fibrous septae can result in shrinkage of the fibrous structure, which may lead to wrinkle reduction and/or tightening of the skin or improvement in the appearance of cellulite. These beneficial results can be achieved by using the exemplary embodiments of systems, processes and apparatus of the present invention described herein, which can allow the septae to be selectively heated while sparing the surrounding fat from the thermal damage. Additional beneficial results may be obtained by applying several passes of the ultrasound energy over a single treatment area at slightly different focal depths. This exemplary procedure can generate heating of the septae at different depths within the fatty layer, which can lead to more extensive and uniform shrinkage of the fibrous septae.

As an example of the ability of the focused ultrasound to produce selective damage to the fibrous septae, an experiment was carried out using a prototype spot-focused high-frequency ultrasound device with a 7.5 Mhz transducer, a focal length of 4 mm below the skin surface, and a maximum power output of 45 W. The transducer was operated in pulsed mode with a pulse length of 150 ms, which corresponds to a delivered energy of about 6.8 J. The focus spot diameter was about 0.3 mm.

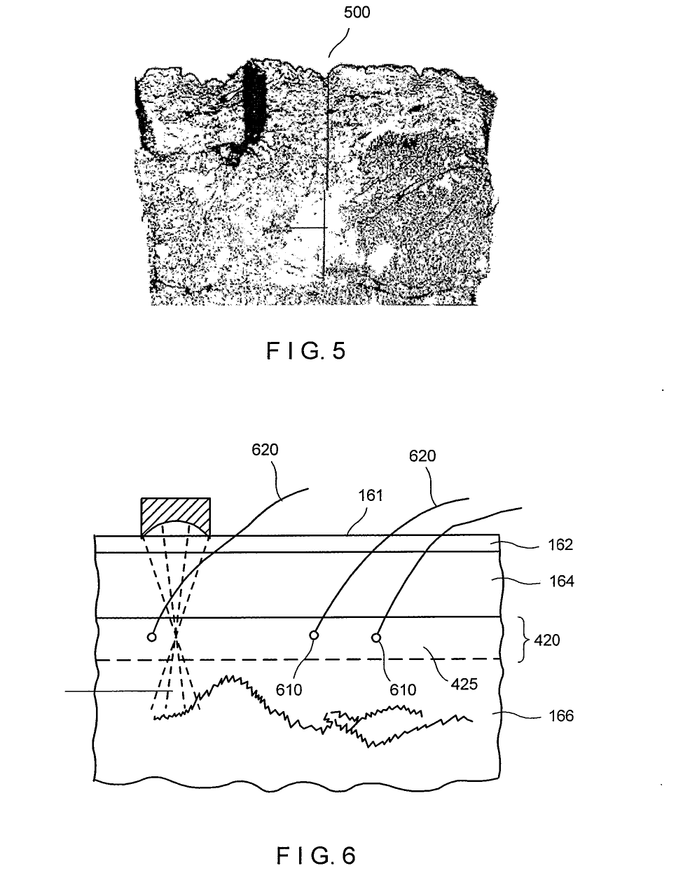

An exemplary cross-section 500 of the skin tissue that was exposed to ultrasound energy is shown in FIG. 5. LDH staining was used to aid in the identification of the damaged tissue. The observed damage depth was about 2.8 mm, and the diameter was about 0.9×2.2. mm. Selective thermal damage of the fibrous septae was seen, and no apparent thermal damage to the epidermis, dermis or surrounding fat was observed.

According to further exemplary embodiments of the present invention, selective heating of the superficial musculoaponeurotic system (SMAS) can be achieved using the exemplary systems, processes and apparatus similar to those described above. The SMAS is a collagen-based tissue structure that, in part, connects facial skin to the underlying muscle tissue. Heating of the SMAS to a sufficient degree to cause thermal damage can lead to a tightening of the overlying facial skin, and a reduction in the appearance of wrinkles. Thus, a non-invasive facelift procedure may be achieved using the exemplary systems, processes and apparatus described herein above. For the selective heating of the SMAS, the focal depth can be selected to be about 0.4 to 1.5 cm, or preferably about 0.7 to 1.2 cm.

In further exemplary embodiments of the present invention, exemplary systems, processes and apparatus can be provided for removal of hair and/or the control of hair growth. An exemplary illustration of this process is shown in FIG. 6. For example, the matrix 610 of anagen hair 620, which generally contains a collection of epithelial cells that are actively growing and dividing, often can lie just below the dermis 164 in the fatty layer 166. Using the exemplary systems, processes and apparatus according to the present invention described herein, the focused ultrasound source 200 described above with the reference to FIG. 2 may be used to apply ultrasound energy to a treatment zone 425 that is provided immediately below the dermis 164, and which contains the fatty tissue 166 and anagen hair matrix 610.

The hair matrix 610 has a layered structure which can absorb ultrasound energy more easily than the relatively homogenous surrounding fatty tissue 166. Selective damage of the hair matrix 610 can be achieved, while sparing the surrounding fatty tissue 166 from the thermal damage. This selectivity can be achieved, for example, by a combination of the greater absorption of ultrasound energy and the greater sensitivity to thermal trauma by the matrix 610 as compared to the fatty layer 166. This selective heating can lead to a control of hair growth and/or temporary hair removal in the treated area. It is also possible to achieve a permanent hair removal with repeated treatments using ultrasound energy over a period of time. The exemplary use of thermal damage to affect hair growth is described, e.g., in International Publication No. WO 03/07783.

Exemplary parameters applicable for selectively damaging the anagen hair matrix and/or the tissue structures located within or around the hair matrix 610, such as the sheath or the papilla, are similar to those used to selectively heat the fibrous septae as described herein. Slightly lower power levels may be effective in controlling the growth of hair and/or providing temporary hair removal. For example, the ultrasound energy can be provided in a focused line having a width of, e.g., about 0.5-1 mm, and the output power of the linear-focused transducer may be in the range of, e.g., about 20-100 W per cm of the focused line. The ultrasound frequency can be, e.g., about 5-10 Mhz, and preferably about 7-8 Mhz. The focal depth can be, e.g., about 4 to 8 mm below the skin surface, and preferably about 6 mm. Optionally, the exemplary ultrasound apparatus 100 shown in FIG. 1 may include a detector that facilitates a detection of the depth of the dermal layer by using feedback of ultrasound waves generated by the ultrasound source 130. This would permit more accurate setting of the focal depth to the upper region of the fatty layer 166 to improve the efficacy of hair removal or growth control.

The exemplary system, process and apparatus for hair removal and growth control described herein has a number of advantages over other techniques that use optical energy such as lasers. Unlike a laser-based system, the ultrasound apparatus presents little or no danger of eye damage from an accidental exposure. Also, superficial cooling of the skin surface is often required for laser-based techniques, but are not necessary for the exemplary ultrasound procedures described herein. The exemplary ultrasound system, process and apparatus are generally not affected by pigmentation. Thus, the exemplary system, process and apparatus according to the present invention may be used by individuals with darker skin color, and it will also be effective in removing light-colored hair.

Conventional laser-based techniques may be ineffective under these circumstances, as a high degree of contrast is required between the hair and the surrounding skin to obtain selective absorption of the applied electromagnetic energy. Additionally, there is little or no danger of accidental burns occurring when the ultrasound apparatus is removed from the skin surface. This can be because the acoustic energy decouples from the skin when physical contact is lost, and the ultrasound energy will no longer penetrate the skin. In contrast, a focused laser device in accordance with exemplary embodiments of the present invention can cause accidental burns if the focal point contacts skin or other tissue.

Thus, the exemplary system, process and apparatus according to the present invention may be safer for home use than alternative conventional systems and methods. This may be because, e.g., the energies used are sufficiently low to avoid skin damage.

In contrast to shaving, which cuts hairs at or above the skin surface, the exemplary system, process and apparatus of the present invention can damage the anagen hair below the skin surface, thereby presenting a smoother, cleaner, more complete hair removal. In contrast, other conventional methods of hair removal, including shaving, waxing, plucking, tweezing, electrolysis, laser light application, incoherent light application, or the use of depilatories, may use the protrusion of the hairs at the skin surface.

It should be understood that the exemplary embodiments of the present invention described herein may be used in professional settings, e.g., in spas or salons by professional cosmetic service providers, or by licensed medical professionals in medical offices. Higher energies may be used in such settings if needed to obtain more satisfactory effects. Even higher energies and more complex settings may be.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

It will thus be appreciated that those skilled in the art will be able to devise numerous systems, arrangements and methods which, although not explicitly shown or described herein, embody the principles of the invention and are thus within the spirit and scope of the present invention. In addition, all publications, patents and patent applications referenced herein are incorporated herein by reference in their entireties.

What is claimed is:

1. A method for treating dermatological conditions, comprising:
focusing ultrasound energy into a particular volume of tissue below a dermis portion thereof such that a first portion of the particular volume is thermally damaged by the ultrasound energy and a second portion of the particular volume remains thermally undamaged by the ultrasound energy.

2. The method of claim 1, wherein the second portion comprises fatty tissue.

3. The method of claim 1, wherein the first portion comprises a collagen structure.

4. The method of claim 3, wherein the collagen structure comprises fibrous septae.

5. The method of claim 4, wherein the particular volume is between about 2 mm and 20 mm below an external surface of the tissue.

6. The method of claim 5, wherein the particular volume is between about 5 mm and 10 mm below an external surface of the tissue.

7. The method of claim 4, wherein the ultrasound energy has a frequency between about 1 MHz and 10 MHz.

8. The method of claim 4, wherein the ultrasound energy has a frequency between about 3 MHz and 8 MHz.

9. The method of claim 4, wherein the ultrasound energy has a frequency of about 5 MHz.

10. The method of claim 1, wherein the particular volume is approximately spherical and has a diameter of between about 0.5 mm and 1 mm.

11. The method of claim 1, wherein the particular volume has a form of a line, and wherein a width of the line is between about 0.5 mm and 1 mm.

12. The method of claim 11, further comprising translating an arrangement providing the ultrasound energy in a direction approximately parallel to a surface of the tissue and in a direction approximately perpendicular to a direction of the line.

13. The method of claim 1, wherein the ultrasound energy is provided in a form of a plurality of pulses.

14. The method of claim 2, wherein the wherein the first portion comprises at least one hair matrix.

15. The method of claim 14, wherein the particular volume is between about 4 mm and 8 mm below an outer surface of the tissue.

16. The method of claim 15, wherein the particular volume is about 6 mm below an outer surface of the tissue.

17. The method of claim 14, wherein the ultrasound energy has a frequency between about 5 MHz and 10 MHz.

18. The method of claim 14, wherein the ultrasound energy has a frequency between about 7 MHz and 8 MHz.

19. The method of claim 4, wherein the ultrasound energy has a frequency of about 5 MHz.

20. The method of claim 1, wherein the wherein the first portion comprises a superficial musculoaponeurotic system.

21. An apparatus for treating dermatological conditions, comprising:
an arrangement configured to focus ultrasound energy into a particular volume of tissue below a dermis portion thereof such that a first portion of the particular volume is thermally damaged by the ultrasound energy and a second portion of the particular volume remains thermally undamaged by the ultrasound energy.
